(19) United States
(12) Patent Application Publication
(10) Pub. No.: US 2020/0255948 A1
(43) Pub. Date: Aug. 13, 2020

(54) ANTI-MULTIPACTOR COATING DEPOSITED ON AN RF OR MW METAL COMPONENT, METHOD FOR FORMING SAME BY LASER SURFACE TEXTURING

(71) Applicant: Radiall, Aubervilliers (FR)

(72) Inventors: Pauline CAILLAUD, Voiron (FR); Fabrice JANOT, L'lsle d' Abeau (FR)

(21) Appl. No.: 16/788,086

(22) Filed: Feb. 11, 2020

(30) Foreign Application Priority Data
Feb. 11, 2019 (FR) 1901338

(51) Int. Cl. C23C 18/16; C23C 18/18; C23C 18/38; C23C 18/42; H01P 11/00

(52) U.S. Cl. CPC C23C 18/1669; C23C 18/165; H01P 11/001; C23C 18/38; C23C 18/42; C23C 18/1841

(57) ABSTRACT

Anti-multipactor coating deposited on an RF or MW component, by surface texturing of such a coating by laser.

The invention relates to a formation method by laser ablation, on a metal substrate, of an anti-multipactor coating whose constituent material is chosen from amongst the metals of column 10 or column 11 of the Mendeleev table or an alloy of these metals and whose texture comprises one or more patterns of cavities repeated at regular intervals, the interval pitch between two adjacent cavities being in the range between 0 and 100 μm.

### TECHNICAL FIELD

The subject of the present invention is an anti-multipactor coating deposited on a metal component and a method for forming this coating.

Here and in the framework of the invention, an “anti-multipactor coating” is understood to refer to a coating whose function is to eliminate, or at the very least greatly reduce, the effect referred to as the “multipactor effect”.

The invention is applicable to any component of a device designed to provide the transmission and/or reception of radio-frequency signals (RF) or signals in the microwave (MW) range for space telecommunications, such as for example connectors or switches.

The invention is also applicable in the nuclear field and, generally speaking, to any application where there exists a risk of a multipactor effect.

The invention may, in particular, be applied to the contacts of connectors, of coaxial or waveguide switches, or to antennas.

### PRIOR ART

The multipactor effect is a vacuum electronic discharge phenomenon, which occurs when, under the effect of an alternating electric field, primary electrons cause secondary electrons to be emitted from the wall of a radiofrequency component, such as a waveguide or a contact.

These emitted secondary electrons are, in turn, accelerated by the applied alternating electric field, and also themselves cause secondary electrons to be emitted from the opposite wall of the component.

Under certain conditions, in particular under the vacuum of space, a multiplier or avalanche effect takes hold, leading to an electronic discharge or a breakdown in the residual low-pressure gas, which can damage the structures.

In particular, in high-power transmission devices, a multipactor effect may occur in space-based microwave (MW) and radiofrequency (RF) connection systems or instrumentation, as in the structures of large thermo-nuclear toroidal plasma systems.

In particle accelerators, which use a wide variety of geometries and operate in a frequency range going from a few MHz to tens of GHz, the multipactor effect limits the maximum power that may be transmitted in these high-power devices which operate under vacuum conditions.

In fact, in all high-power RF connection devices designed to go into space, large particle accelerators, klystrons and other RF high-power vacuum tubes, the multipactor effect can have a significant detrimental impact.

One known solution for eliminating, or at the very least reducing as far as possible, this multipactor effect consists in depositing a suitable coating on the surfaces of the components in question.

Such a coating, referred to as ‘anti-multipactor coating’, must exhibit a sufficient surface electrical conductivity, in order to minimize the RF losses, a high resistance upon exposing to air and a low capacity for re-emission of secondary electrons.

The latter point is known by the acronym SEY (for “Secondary Electron Yield”).

Thus, an anti-multipactor coating has to reduce the SEY as much as possible.

One of the solutions consists in creating a non-planar, irregular surface in the regions that are able to emit these secondary electrons. These electrons are then trapped in part within this irregular surface texture.

The Patent application US2017/0292190 provides an anti-multipactor coating deposited on a metal substrate by chemical means which notably requires the use of an acid for the implementation of an etch step. The disclosed coating exhibits performance characteristics which are far from being perfect. Furthermore, the chemical etching method is carried out by immersion in one or more chemical baths and, on the one hand, it does not allow, or only allows at the expense of very restrictive measures, coatings to be deposited localized only in certain regions of components. On the other hand, it does not allow a gold coating to be implemented, which is one of the most chemically inert metals, but which however constitutes one of the ideal candidates for the anti-multipactor effect sought. Furthermore, the method can generate coatings whose texture is not uniform, and which may leave poorly textured areas and hence which may be a source of an increase in the SEY.

Publication [1] describes the production of micro-pores by a mixed process electroplating/photolithography in a gold layer formed on a silicon substrate coated with a layer of SiN.

Publication [2] discloses the realization by photolithography of an RF component (bridge filter in the K-band) comprising an aluminum substrate on which is deposited by photolithography a coating of Ag.

The methods according to publications [1] and [2] generate simple shapes of holes whose shape of walls cannot be controlled. Also, these methods cannot produce pores on two-dimensional surfaces, and are therefore not suitable for products, such as RF components, whose surfaces are three-dimensional with in particular adjoining walls, perpendicular to each other. In addition, these photolithographic methods cannot be used for the interior or exterior of cylindrical surfaces or with a large radius of curvature and/or large sizes. Finally, these methods have intrinsic drawbacks to photolithography, namely on the one hand the need for a specific environment in a clean room and on the other hand the use of organic resin little recommended for space applications, and requiring complementary processes and heavy thorough cleaning to avoid the risk of degassing.

Furthermore, patent application CN108767413 discloses MW components intended for space, the surface of which is ablated by a laser to suppress the phenomenon of micro-discharge. The planned topography is of the order of several hundred μm, which does not allow an optimal anti-multipactor effect for current applications.

There accordingly exists a need to improve anti-multipactor coatings and their method of formation, notably in order to obtain a low SEY, a sufficient surface electrical conductivity, a high resistance upon exposure to air, and in order to best conserve the electrical performance characteristics for transmission of RF signals by metal components comprising these coatings.

The aim of the invention is to satisfy at least partially this need.

### SUMMARY OF THE INVENTION

For this purpose, one subject of the invention is a method for forming an anti-multipactor coating on a metal substrate, comprising the following steps:
(a) deposition of a coating made of a constituent material chosen from amongst the metals of column 10 or column 11 of the Mendeleev table or an alloy of these metals, over at least a part of the surface of the metal substrate,
(b) laser treatment of the coating deposited according to the step (a), in such a manner as to obtain a texturing of the deposited coating, with one or more patterns of cavities repeated at regular intervals, the pitch of the interval between two adjacent cavities being in the range between 0 and 100 μm.

The opening diameter of each cavity can be in the range between 2 and 50 μm, preferably between 2 and 30 μm.

Where appropriate, prior to the step (a), the method may comprise a step for deposition of an adhesion layer for the coating.

Advantageously, the material composing the coating deposited according to the step (a) is chosen from amongst gold, silver, an alloy of silver, preferably an alloy of gold, a gold-nickel or gold-cobalt alloy.

According to one advantageous variant embodiment, the step (b) is carried out by means of a femtosecond laser. It is recalled here that, in contrast to a conventional laser, which usually produces a continuous radiation, a femtosecond laser produces very short flashes, i.e. pulses, of light. Each pulse preferably lasts from a few fs to 100 fs, 1 fs being equal to 10⁻¹⁵ s.

One of the advantages of a femtosecond laser is to have a region thermally affected by its impact which is very small. Furthermore, a femtosecond laser allows patterns of cavities that are perfectly repeated at regular intervals to be obtained, which is what is desired in the framework of the invention.

Preferably, the step (a) is carried out according to an electrochemical surface treatment (chemical or electrolytic coating) technique.

According to one advantageous variant embodiment, prior to step (a), a step of coating the metal substrate with at least one thin layer deposited according to a physical vapour deposition (PVD) technique is achieved.

Preferably, the thin layer is a gold layer.

The subject of the invention is also the use of an RF or MW component such as hereinabove notably for the transmission of signals from or to a satellite, which at least a part of the surface of the active part at least a part of the surface of the active part of which is composed of a metal substrate coated with the anti-multipactor coating according to the formation method such as mentioned above. These may for example be waveguide switches for transmission and/or reception in the P, S, L, C or X bands or, alternatively, coaxial switches for transmission and/or reception in all the frequency bands of the electromagnetic spectrum.

Thus, the invention essentially consists of an anti-multipactor coating, preferably of gold or of silver or an alloy of these metals, which is textured by laser ablation which allows to creat cavities of calibrated geometry and repeated in a regular manner with a pitch of interval between 0 and 100 μm, over the part of the surface of the metal component which has this texturing.

The cavities act as very efficient traps for primary electrons, which allows a reduced SEY to be obtained. In addition, having these patterns of cavities repeated at regular intervals implies a uniform coating texture, which also promotes a reduced SEY.

The reduced distance between cavities greatly limits the multipactor effect, which dominates the two-dimensional surfaces.

By virtue of the anti-multipactor coating according to the invention, the performance characteristics in terms of power of transmission of HF or MW signals may be considerably improved compared with a conducting metal coating, notably of gold or of silver, formed only by deposition according to a surface treatment technique of the electrochemical (chemical or electrolytic) deposition type for example, without however significantly degrading the RF or MW performance, such as the level of RF losses during the transmission of an RF signal.

Moreover, the use of a laser for texturing the surface of the deposited coating allows the type of texturing (size and depth of the cavities, periodicity of the pattern) to be readily controlled and adjusted and the surfaces of the substrate, able to emit secondary electrons, to only be treated locally in contrast to a chemical etching according to the prior art which is applied in a bath in which the component to be treated is immersed.

In addition, texturing by laser ablation makes it possible to create cavities whose shape is perfectly cylindrical and, in addition to the cavities, microcavities on the walls of the latter which have a sponge shape. Obtaining these forms is very favorable to the anti-multipactor effect.

In addition, the texturing by laser ablation according to the invention makes it possible to obtain cavity depths which are small, unlike the methods according to the prior art, which is advantageous since the consumption of precious metals on the surface, in particular gold, and therefore the related costs can be reduced.

Lastly, texturing by laser allows the surface of a gold coating to be readily modified, which is difficult, or even impossible, by chemical attack.

Other advantages and features of the invention will become more clearly apparent upon reading the detailed description of exemplary embodiments of the invention presented by way of non-limiting illustration with reference to the following figures.

### BRIEF DESCRIPTION OF THE DRAWINGS

FIG. 1 is a photographic reproduction of an anti-multipactor coating according to the invention;

FIG. 2A is a schematic top view of repeated patterns of cavities of an anti-multipactor coating according to the invention;

FIG. 2B1 is a schematic longitudinal cross-sectional view of a cavity of an anti-multipactor coating according to the invention;

FIG. 3 is a display, obtained by 3D laser scanning confocal microscope, of the topography of an anti-multipactor coating with patterns of cavities repeated at regular intervals according to the invention;

FIG. 4 is a perspective view of a coaxial connector of the TNC type implemented for testing an anti-multipactor coating according to the invention;

FIG. 5 is a perspective view of a socket implemented for testing an anti-multipactor coating according to the invention;

FIG. 6 is a perspective view of a connector half-shell implementation for testing an anti-multipactor coating according to the invention;

FIG. 7 is a perspective view of a connection system comprising two TNC connectors such as shown in FIG. 4, between which a connection socket according to FIG. 5 is connected and surrounded by two connector half-shells according to FIG. 6, the exterior of the socket and the interior of the connector half-shells being covered with an anti-multipactor coating of silver according to the invention;

FIG. 8 is a perspective view of the connection system according to FIG. 7 such as assembled;

FIG. 9A is a a scanning electron microscope (SEM) view with a magnification ×250 of an anti-multipactor coating of silver according to the invention which covers the exterior of the socket and the interior of the connector half-shells;

FIG. 9B1 is a a scanning electron microscope (SEM) view with a magnification ×1000 of an anti-multipactor coating of silver according to the invention which covers the exterior of the socket and the interior of the connector half-shells;

FIG. 9C1 is a a scanning electron microscope (SEM) view with a magnification ×5000 of an anti-multipactor coating of silver according to the invention which covers the exterior of the socket and the interior of the connector half-shells, this magnification allowing a cavity to be viewed;

FIG. 9D1 is a a scanning electron microscope (SEM) view with a magnification ×7500 of an anti-multipactor coating of silver according to the invention which covers the exterior of the socket and the interior of the connector half-shells, this magnification allowing the cavity in FIG. 9C to be seen with a greater precision;

FIG. 10 is a perspective view of a connection system comprising two TNC connectors such as shown in FIG. 4 between which a connection socket according to FIG. 5 is connected and surrounded by two connector half-shells according to FIG. 6, the exterior of the socket and the interior of the connector half-shells being covered with an anti-multipactor coating of gold according to the invention;

FIG. 11A is a a scanning electron microscope (SEM) view with a magnification ×550 of an anti-multipactor coating of gold according to the invention which covers the exterior of the socket and the interior of the connector half-shells;

FIG. 11B is a a scanning electron microscope (SEM) view with a magnification ×1000 of an anti-multipactor coating of gold according to the invention which covers the exterior of the socket and the interior of the connector half-shells;

FIG. 11C is a a scanning electron microscope (SEM) view with a magnification ×6000 of an anti-multipactor coating of gold according to the invention which covers the exterior of the socket and the interior of the connector half-shells, this magnification allowing a cavity to be viewed;

FIG. 11D is a view of a scanning electron microscope (SEM) with a magnification ×7500 of an anti-multipactor coating of gold according to the invention which covers the exterior of the socket and the interior of the connector half-shells, this magnification allowing the cavity of FIG. 11C to be seen with a greater precision;

FIG. 12 is a graph in the form of histograms showing the gain in transmission power provided by an anti-multipactor coating of silver and of gold according to the invention compared with a coating respectively of silver and of gold according to the prior art, obtained by electrochemical surface treatment only, without texturing.

### DETAILED DESCRIPTION

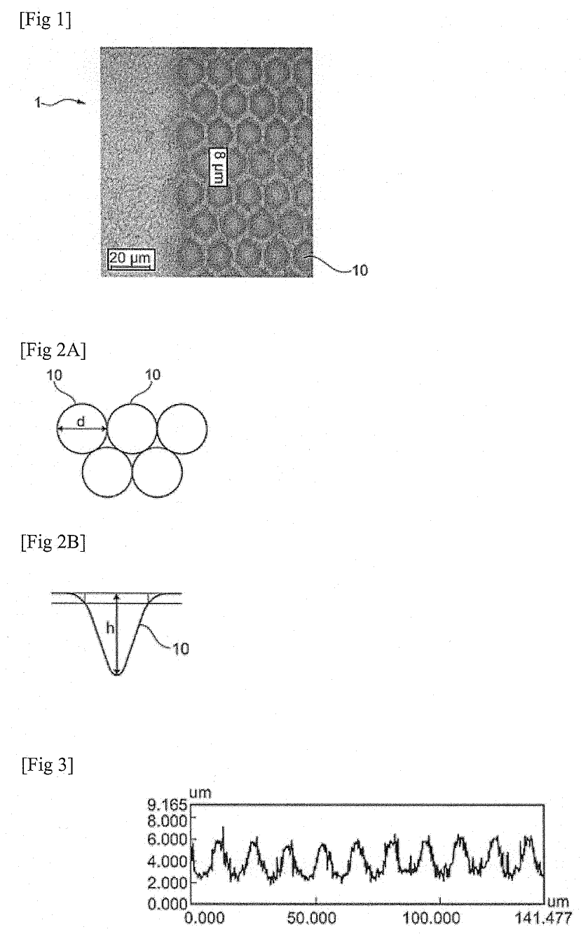

FIG. 1 illustrates an anti-multipactor coating, denoted overall by the reference 1, according to the invention.

This coating 1 is a layer of silver, gold, or an alloy of one or the other of these metals and its texture comprises one or more patterns of cavities repeated at regular intervals 10.

A schematic representation of repeated patterns and of cavities 10 is shown in FIGS. 2A to 2B: the cavities 10 are substantially adjoining and each has a circular opening and a general cross-sectional shape substantially in the form of a Gaussian. By way of indicative example, the unitary diameter of the cavities 10 is of the order of 20 μm and their depth (height) h is of the order of 4 μm.

The topography repeating at regular intervals of these cavities 10 is clearly visible in FIG. 3.

In order to obtain the anti-multipactor coating 1 according to the invention over at least a part of the surface of a metal RF or MW component, the inventors have carried out the following steps.

Step a): a deposition is carried out by surface treatment of the electrochemical deposition type for example of a gold or silver coating, or of an alloy of one or the other of these metals, selectively over the surface of the metal component in question.

This deposition is of the order of a few μm, or even a few tens of μm. For example, the thickness of deposition may be in the range between 1 and 15 μm for silver and 1 and 7 μm for pure gold.

Step b): a laser treatment of the deposited coating is carried out, in such a manner as to obtain a texturing of the deposited coating, with one or more patterns of cavities repeated at regular intervals.

The laser used is preferably a femtosecond laser. Each cavity 10 is created by a pulse produced by the laser, with a duration of a few fs to 100 fs.

In order to test the effectiveness of the anti-multipactor coating 1 according to the invention, the inventors have carried out trials on an RF test vehicle, a part of the metal components of which is coated with the said coating.

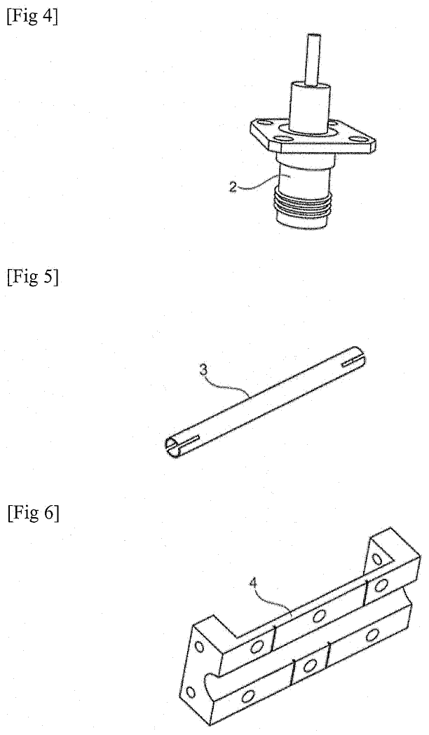

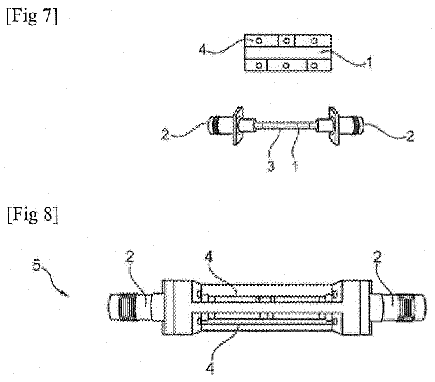

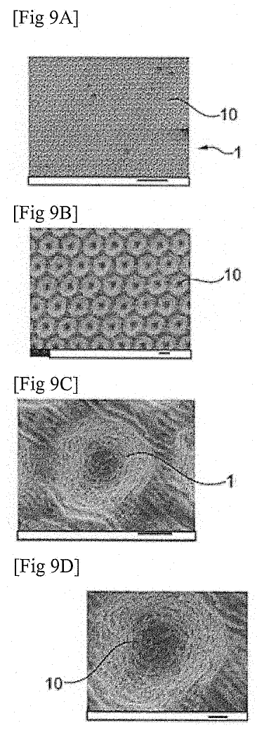

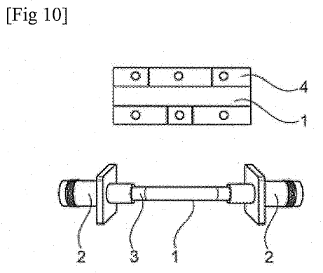

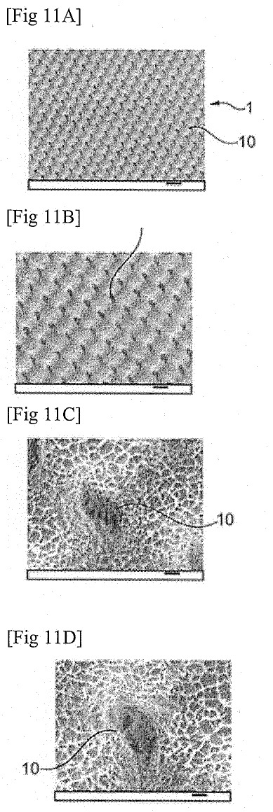

The connection system used 5 during the trials comprises two coaxial connectors 4 of the TNC type, such as shown in FIG. 4, between which a socket 3 shown in FIG. 5 is connected and around which two connector half-shells 4, as shown in FIG. 6, are assembled defining an annular space around it.

The connection system 5 assembled and in an operational configuration is shown in FIG. 8.

In each of the examples considered hereinafter, the conditions of the trials were as follows:
socket 3 made of copper beryllium (CuBe₂) and connector half-shell 4 made of aluminium;
frequency of the signal transmitted by the connection system 5: 1 GHz;
annular space between the exterior of the socket 3 and the interior of the cylinder defined by the two assembled connector half-shells 4: 2 mm;
power of transmission of the signal: until the multipactor discharge is obtained.

Example 1: The exterior of the socket 3 and the interior of the connector half-shells 4 is coated with an anti-multipactor coating 1 made of silver and textured according to the invention, i.e. according to the steps a) and b) of the method described hereinabove.

Comparative example 1: The exterior of the socket 3 and the interior of the connector half-shells 4 are coated with a silver coating 1 but without any texturing, i.e. according to the step a) only of the method described hereinabove.

Example 2: The exterior of the socket 3 and the interior of the connector half-shells 4 are coated with a gold anti-multipactor coating 2 and textured according to the invention, i.e. according to the steps a) and b) of the method described hereinabove.

Comparative example 2: The exterior of the socket 3 and the interior of the connector half-shells 4 are coated with a gold layer 2 but without any texturing, i.e. according to the step a) only of the method described hereinabove.

Comparative example 3: The socket 3 and the connector half-shells 4 have no coating.

The measurements of power of the signal were made according to the standard cited in the reference hereinafter.

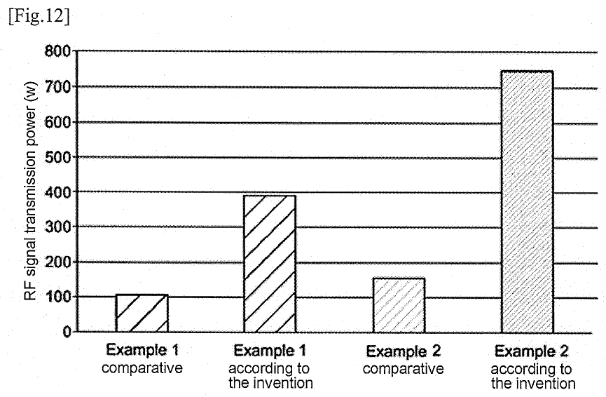

The results of the trials are shown in FIG. 12 and summarized in Table 1 hereinbelow.

TABLE 1

| Example | Power (W) |
|---|---|
| Example 1 | 390 |
| Comparative example 1 | 105 |
| Example 2 | 750 |
| Comparative example 2 | 153 |
| Example 3 | 80 |

It is observed that the best result is obtained with a gold coating 1 textured according to the invention, with a gain by a factor of the order of 4.9 with respect to a coating that is gold plated only, which is already considerable, and a gain by a factor of the order of 9.38 compared with metal components with no coating, which is very significant.

A silver coating 1 textured according to the invention, for its part, provides a gain by a factor of around 2.95 with respect to a coating which is silver plated only.

Other variants and advantages of the invention may be implemented without however straying from the scope of the invention.

For example, although, in the example illustrated, the anti-multipactor coating according to the invention is deposited on a socket forming a central contact of an RF connection system, the invention is also applicable to any other electrically-conductive part of an RF or MW device, notably for high-power transmission, of a switch, such as a coaxial switch or a waveguide switch.

The invention is not limited to the examples that have just been described; features of the examples illustrated may notably be combined together within variants not shown.

### LIST OF THE DOCUMENTS CITED

[1] Sattler et al. «Modeling micro-porous surfaces for secondary electron emission control to suppress multipactor», Journal of Applied Physics, American Institute of Physics, Vol. 122, N° 5, 7 Août 2017.
[2] Wang et al. «A novel method to improve the power capabilities of microwave components», 2013 European Microwave Integrated Circuit Conference; European Microwave Association, 6 Oct. 2013.
[3] ECSS-E-20-01A (REV-1), SPACE ENGINEERING: MULTIPACTION DESIGN AND TEST (1 Mar. 2013)

1. A method for forming an anti-multipactor coating on a metal substrate, comprising the following steps:
(a) deposition of a coating made of a constituent material chosen from amongst the metals of column 10 or column 11 of the Mendeleev table or an alloy of these metals over at least a part of the surface of the metal substrate,
(b) laser treatment of the coating deposited according to the step (a), in such a manner as to obtain a texturing of the deposited coating, with one or more patterns of cavities repeated at regular intervals, the interval pitch between two adjacent cavities being in the range between 0 and 100 μm.

2. The formation method according to claim 1, comprising, prior to the step (a), a step for deposition of an adhesion layer for the coating.

3. The formation method according to claim 1, wherein the constituent material of the coating deposited according to the step (a) is chosen from amongst gold, silver, an alloy of silver, preferably an alloy of gold, a gold-nickel or gold-cobalt alloy.

4. The formation method according to claim 1, wherein the step (b) is carried out by means of a femtosecond laser.

5. The formation method according to claim 1, wherein the step (a) is carried out according to an electrochemical surface treatment technique.

6. The formation method according to claim 1, wherein the opening diameter of each cavity is in the range between 2 and 50 μm, preferably between 2 and 30 μm.

7. The formation method according to claim 1, comprising, prior to step (a), a step of coating the metal substrate with at least one thin layer deposited according to a physical vapour deposition (PVD) technique.

8. The formation method according to claim 7, wherein the thin layer is a gold layer.

9. A radiofrequency (RF) or microwave (MW) component at least a part of the surface of the active part of which is composed of a metal substrate coated with the anti-multipactor coating according to the formation method of claim 1.

10. The radiofrequency (RF) or microwave (MW) component according to claim 9, forming an RF coaxial connector, or an RF switch of the coaxial type or a waveguide.

11. Use of an RF or MW component according to claim 9 for the transmission of signals from or to a satellite.
